(19) United States
(12) Patent Application Publication
(10) Pub. No.: US 2015/0328851 A1
(43) Pub. Date: Nov. 19, 2015

(54) Structure of Vulcanization Machine

(71) Applicant: SUPERIOR STAR ENGINEERING CO., LTD., NEW TAIPEI CITY (TW)

(72) Inventor: Yu Cheng, New Taipei City (TW)

(73) Assignee: SUPERIOR STAR ENGINEERING CO., LTD., NEW TAIPEI CITY (TW)

(21) Appl. No.: 14/279,338

(22) Filed: May 16, 2014

(51) Int. Cl. B29D 30/06

(52) U.S. Cl. CPC B29D 30/0603; B29D 30/065; B29K 2105/246

(57) ABSTRACT

An improved structure of a vulcanization machine is disclosed, including a first material feeding tray assembly on which multiple workpieces are positionable to be transported by a first movable transportation device to a first vulcanization device for vulcanization and molding. The vulcanized and molded workpiece is transported by a second movable transportation device to be placed on a first cooling tray assembly for natural cooling. A second vulcanization module is also provided, having the same structure and operation as those described previously. The second vulcanization module is combinable with the first vulcanization module and they can be operation simultaneously and synchronously for the same production specification or can be operated in a manner of being not simultaneous and asynchronous for products of different specifications. As such, asynchronous operations can be carried out simultaneously to achieve high-mix low-volume production and provide multiple operation modes and enhance competition power.

### (a) TECHNICAL FIELD OF THE INVENTION

The present invention generally relates to an improved structure of a vulcanization machine, and more particularly to an improved structure of a vulcanization machine that enables simultaneous performance of asynchronous operations to achieve high-mix low-volume productions and provides advantages of possessing multiple operation modes and enhancing competition power.

### (b) DESCRIPTION OF THE PRIOR ART

The conventional vulcanizers have a number of problems, which include that a first machine group and a second machine group can only allow for synchronized operations and production of identical sizes and are incapable of asynchronous operations to manufacture workpieces of different sizes, resulting in incapability of simultaneous production of various sizes in a high-mix low-volume manner and thus reduction of competition power; that there is no material feeding tray and cooling tray provided so as to result in incapability of simultaneous placement of multiple workpieces for processing and cooling operation and allowing only for replacement and placement carried out manually, leading to a large consumption of human labor and time, reduction of productivity; and that there is no transportation device provided and transportation can only be done manually, resulting in easy damage of products due to human errors in a transportation process and risk and hurt caused by falling or dropping of the vulcanizer.

For the contemporary users, the conventional vulcanizers are surely not capable of achieving the desired operation performance and often pose problems, which lead to a great burden of use to the users.

### SUMMARY OF THE INVENTION

The primary object of the present invention is to achieve advantages of allowing for asynchronous operations for prompting high-mix low-volume production and having various operation modes and enhancing competition power.

With such a technical solution, the problems of the conventional vulcanizers that the conventional vulcanizers allow for synchronized operations and production of identical sizes and are incapable of asynchronous operations to manufacture workpieces of different sizes, resulting in incapability of simultaneous production of various sizes and thus reduction of competition power; that there is no material feeding tray and cooling tray provided so as to result in incapability of simultaneous placement of multiple workpieces for processing and cooling operation and allowing only for replacement and placement carried out manually, leading to a large consumption of human labor and time, reduction of productivity; and that there is no transportation device provided and transportation can only be done manually, resulting in easy damage of products due to human errors in a transportation process and risk and hurt caused by falling or dropping of the vulcanizer can be effectively overcome and the above mentioned advantages of the present invention can be achieved.

To achieve the above object, the structure of the present invention generally comprises a first vulcanization module and a second vulcanization module. A first single-actuation controller is arranged at one side of the first vulcanization module and a second single-actuation controller is arranged at one side of the second vulcanization module. The first vulcanization module comprises: a first material feeding tray assembly, a first movable transportation device arranged at one side of the first material feeding tray assembly, a first vulcanization device arranged at one side of the first movable transportation device, a second movable transportation device arranged at one side of the first vulcanization device, and a first cooling tray assembly arranged at one side of the second movable transportation device. Further, the second vulcanization module comprises: a second material feeding tray assembly, a third movable transportation device arranged at one side of the second material feeding tray assembly, a second vulcanization device arranged at one side of the third movable transportation device, a fourth movable transportation device arranged at one side of the second vulcanization device, and a second cooling tray assembly arranged at one side of the fourth movable transportation device.

With the above-described structure, the first vulcanization module and the second vulcanization module are respectively activated by the first single-actuation controller and the second single-actuation controller to carry out manufacturing processes. The operation of the first vulcanization module will be described first. The first material feeding tray assembly receives at least three workpieces positioned thereon and then transportation is carried out by the first movable transportation device to have the workpieces transported to the first vulcanization device for vulcanization and molding. At the same time, the vulcanized and molded workpieces of the first vulcanization device are transported by the second movable transportation device so that the workpieces on the second movable transportation device are moved to the first cooling tray assembly for cooling and shape fixing. Further, at the same time when the first vulcanization module is in operation, the second vulcanization module also proceed with an operation. Similarly, the second vulcanization module is activated by the second single-actuation controller to carry out the manufacturing process. The operation of the second vulcanization module will now be described. The second material feeding tray assembly first receives at least three workpieces thereon and transportation is then carried out by the third movable transportation device to have the workpieces transported to the second vulcanization device for vulcanization and molding. The vulcanized and molded workpieces of the second vulcanization device are transported by the fourth movable transportation device so that the workpieces on the fourth movable transportation device are moved to the second cooling tray assembly for cooling and shape fixing. With the above arrangement, the structure and operation of the second vulcanization module are identical to those of the first vulcanization module and the difference is that the second vulcanization module is operable in an asynchronous manner with the first vulcanization module to make products of different sizes so that tires of different sizes can be manufactured simultaneously.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view.

FIG. 2 is a side elevational view.

FIG. 3 is a see-through view.

FIG. 4 is a schematic view illustrating a first single-actuation controller operated to activate a first vulcanization module.

FIG. 5 is a schematic view illustrating a workpiece positioned on a first material feeding tray assembly.

FIG. 6 is a schematic view illustrating the workpiece moved from the first material feeding tray assembly by a first movable transportation device.

FIG. 7 is a schematic view illustrating an operation of vulcanization performed with a first vulcanization device.

FIG. 8 is a schematic view illustrating a vulcanized and molded workpiece moved by a second movable transportation device to a first cooling tray assembly.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

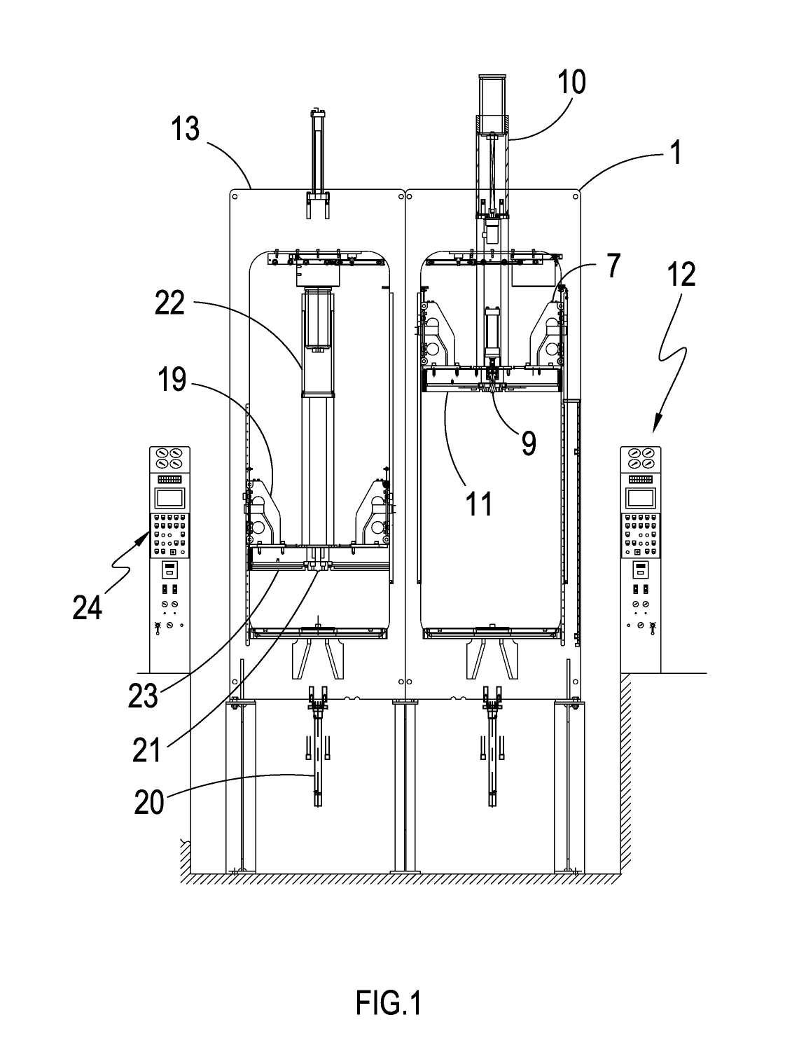

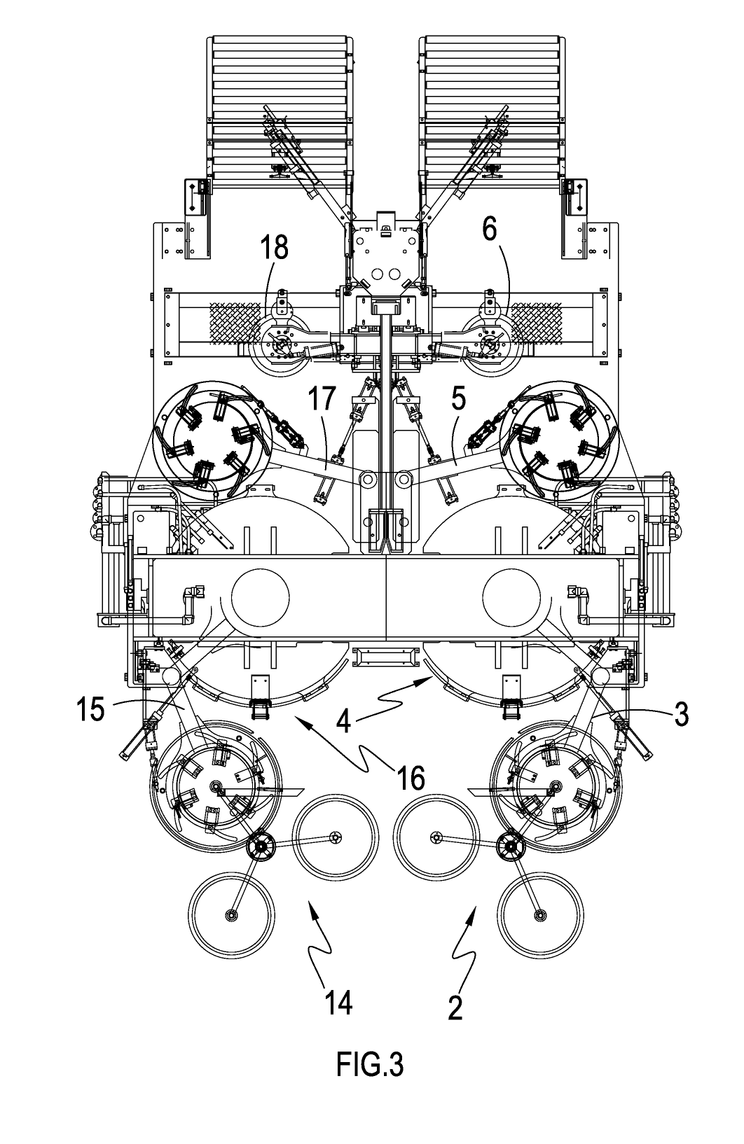

Referring to FIGS. 1 to 3, the present invention comprises:

a first vulcanization module 1, which comprises:

a first material feeding tray assembly 2, which receives at least one workpiece to place thereon;

a first movable transportation device 3, which is arranged at one side of the first material feeding tray assembly 2 to transport the workpiece;

a first vulcanization device 4, which is arranged at one side of the first movable transportation device 3 to receive the workpiece of the first movable transportation device 3 for carrying out vulcanization and molding;

a second movable transportation device 5, which is arranged at one side of the first vulcanization device 4 to transport the workpiece that is vulcanized by the first vulcanization device 4;

a first cooling tray assembly 6, which is arranged at one side of the second movable transportation device 5 to receive the workpiece of the second movable transportation device 5 for carrying out cooling;

a first positioning safety device 7, which is arranged at opposite sides of the first vulcanization device 4;

a first positioning centering device 8, which is arranged at a center of the first vulcanization device 4;

a first separation and mold release device 9, which is arranged on one surface of the first material feeding tray assembly 2;

a first mold height adjustment device 10, which is arranged on one surface of the first vulcanization device 4;

at least one first heating device 11, which is arranged at one side of the first vulcanization device 4;

a first single-actuation controller 12, which is arranged at one side of the first vulcanization module 1 to control a manufacturing process of the first vulcanization module 1;

a second vulcanization module 13, which is arranged at one side of the first vulcanization module 1 and is operable in a manner of being asynchronous with the operation of the first vulcanization module 1, the second vulcanization module 13 comprising:

a second material feeding tray assembly 14, which receives at least one workpiece to place thereon;

a third movable transportation device 15, which is arranged at one side of the second material feeding tray assembly 14 to transport the workpiece;

a second vulcanization device 16, which is arranged at one side of the third movable transportation device 15 to receive the workpiece of the third movable transportation device 15 for carrying out vulcanization and molding;

a fourth movable transportation device 17, which is arranged at one side of the second vulcanization device 16 to transport the workpiece that is vulcanized by the second vulcanization device 16;

a second cooling tray assembly 18, which is arranged at one side of the fourth movable transportation device 17 to receive the workpiece of the fourth movable transportation device 17 for carrying out cooling;

a second positioning safety device 19, which is arranged at opposite sides of the second vulcanization device 16;

a second positioning centering device 20, which is arranged at a center of the second vulcanization device 16;

a second separation and mold release device 21, which is arranged on one surface of the second material feeding tray assembly 14;

a second mold height adjustment device 22, which is arranged on one surface the second vulcanization device 16 and a second heating device 23; and

a second single-actuation controller 24, which is arranged at one side of the second vulcanization module 13 to control a manufacturing process of the second vulcanization module 13, wherein the first vulcanization module 1 and the second vulcanization module 13 are combinable with each other or are separable from each other.

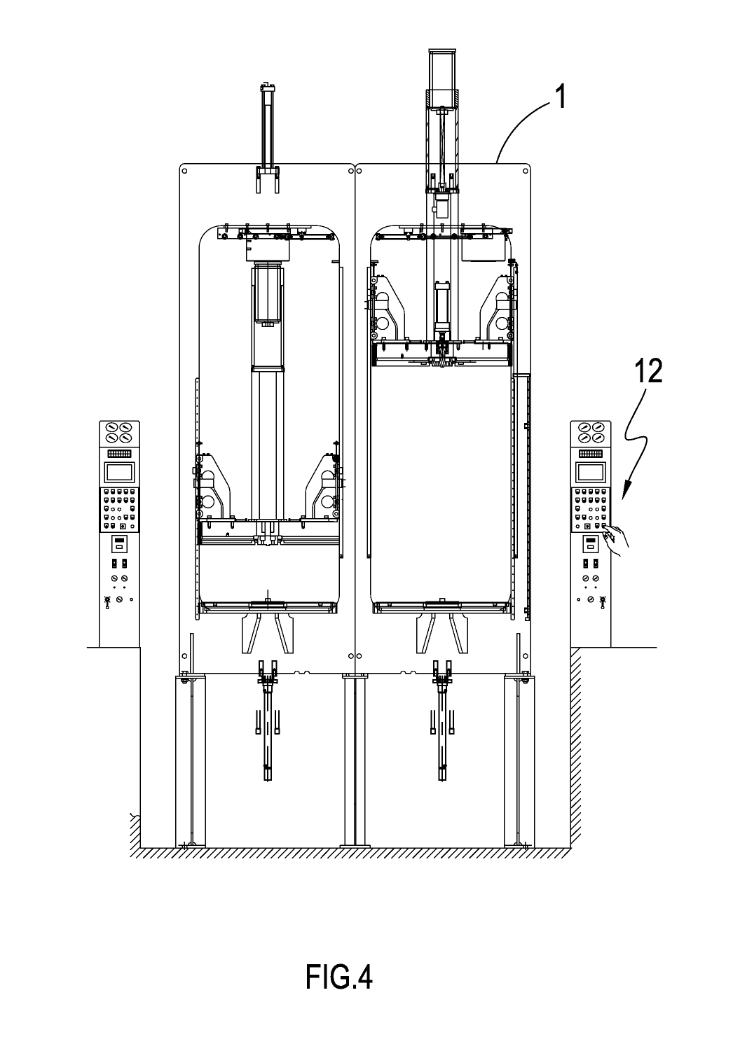

Referring also to FIG. 4, a user first presses the first single-actuation controller 12 to activate the first vulcanization module 1 and controls a manufacturing process thereof

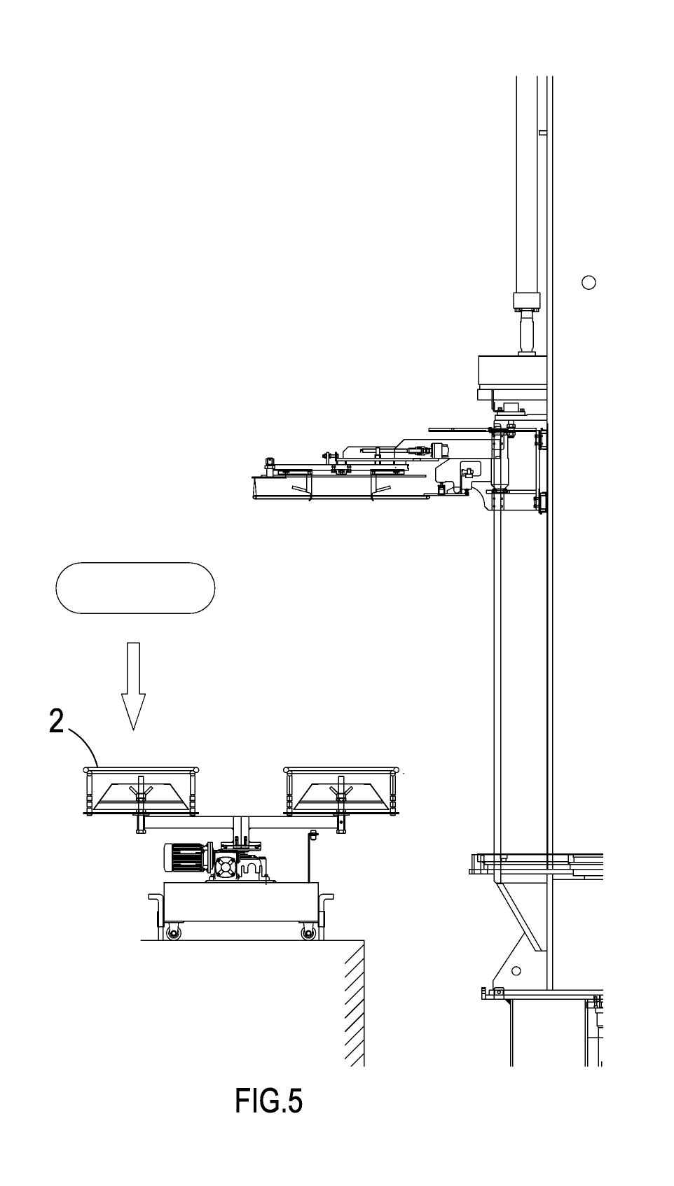

Referring also to FIG. 5, at least three workpieces are positionable on the first material feeding tray assembly 2. When the workpieces are loaded on the first material feeding tray assembly 2, the first material feeding tray assembly 2 is rotated to receive fresh workpieces to be placed thereon.

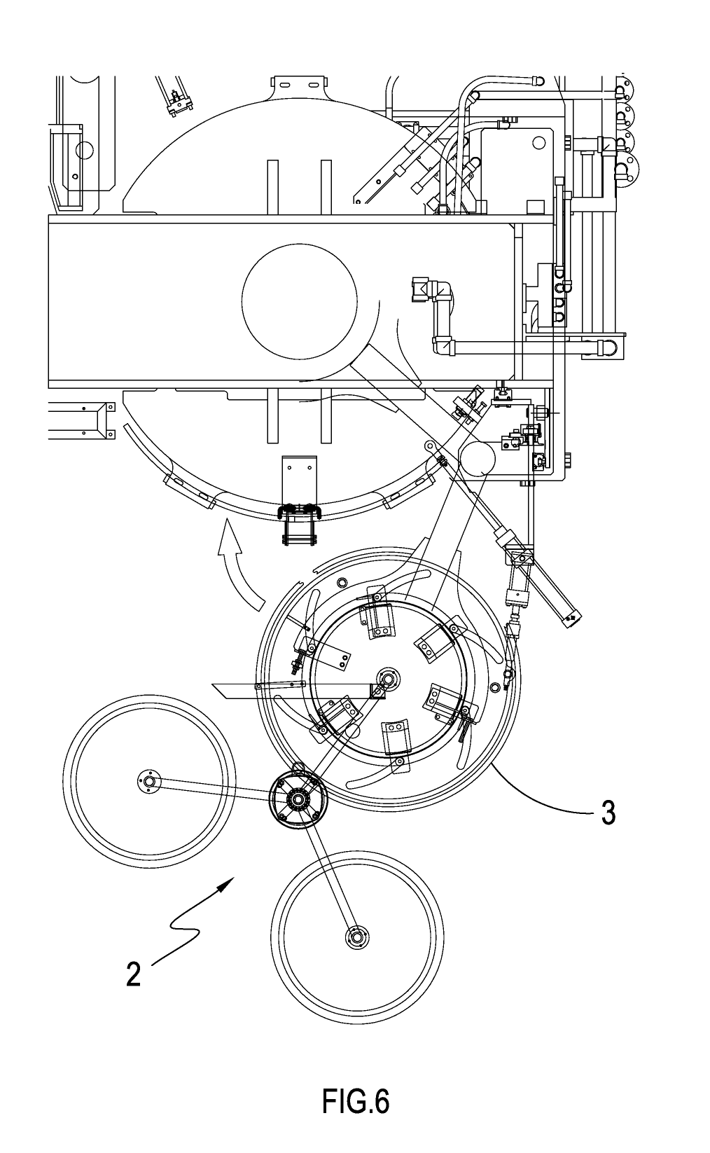

Referring also to FIG. 6, the workpiece of the first material feeding tray assembly 2 is picked up and moved by the first movable transportation device 3.

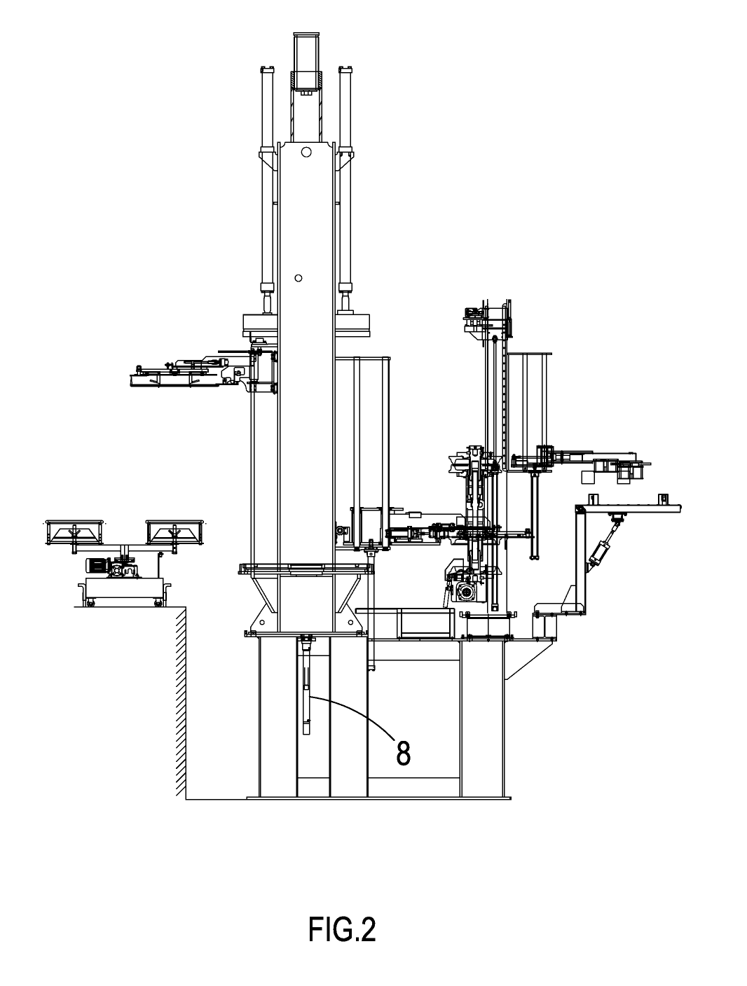

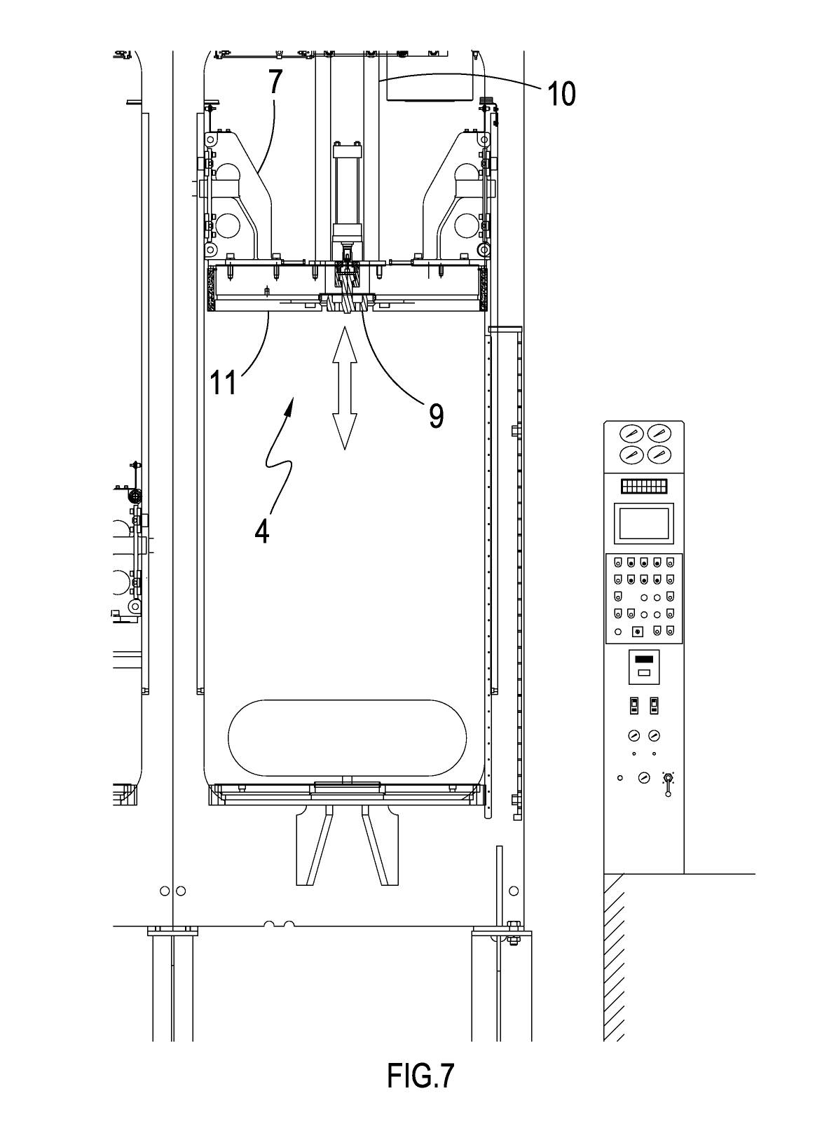

Referring also to FIGS. 2 and 7, the workpiece that is moved and placed in the first vulcanization device 4 is subjected to position adjustment by the first positioning centering device 8 to eliminate undesired positional shifting and to prevent failure of vulcanization and/or damage of the first vulcanization device 4 occurring in a downward movement of the first vulcanization device 4 for vulcanizing the workpiece resulting from the positional shifting. Then, the first vulcanization device 4 moves downwards to carry out vulcanization of the workpiece, wherein during the downward movement and vulcanization operation of the first vulcanization device 4, to prevent over vulcanization that leads to deformation and damage of the workpiece, the first mold height adjustment device 10 is used to adjust the pressure and force applied thereto and the first heating device 11 is applied to simultaneously heat and soften the workpiece that is being vulcanized. After completion of vulcanization and heating, the first vulcanization device 4 automatically moves upwards. Further, the first vulcanization module 1 is provided with the first positioning safety device 7, which helps prevent the first vulcanization device 4 from falling and/or separation during a vulcanization process or a maintenance/repairing process in order to reduce the potential risk of hurting the operators. Finally, the workpiece that has been vulcanized and heated in the first vulcanization device 4 is driven outward and separated from the mold by the first separation and mold release device 9 and such an outward driven and mold separation process helps prevent the heated and thus softened workpiece from being damaged at a recessed portion thereof during separation from the mold.

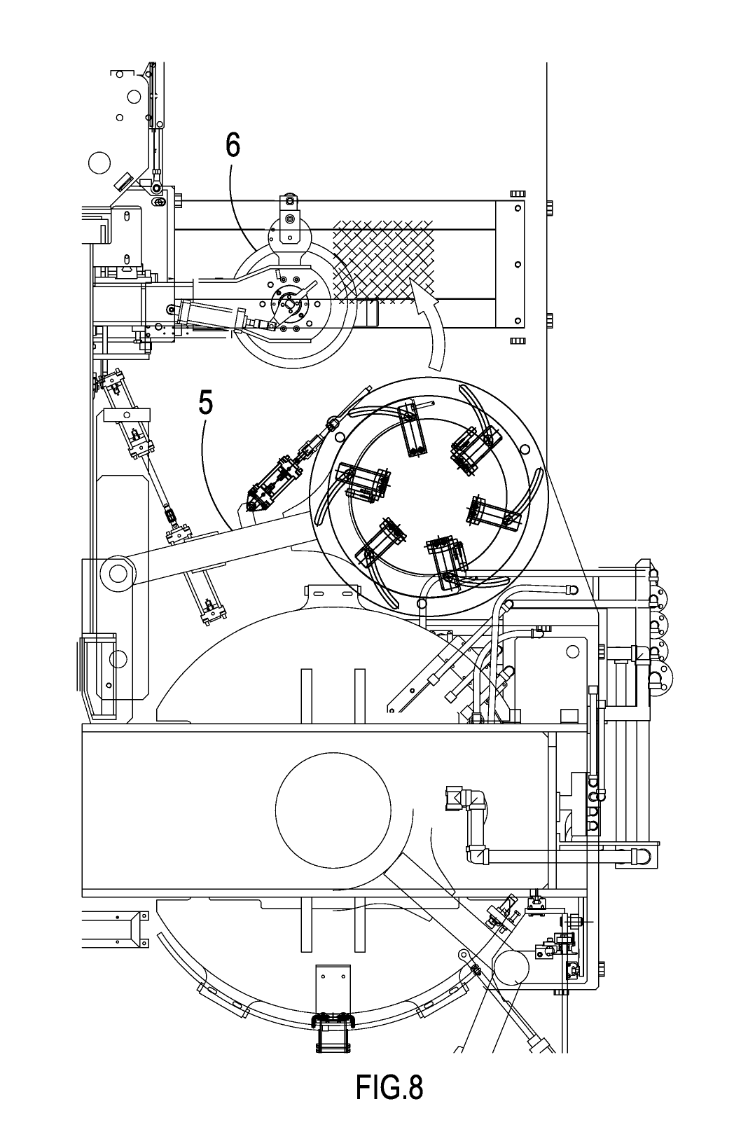

Referring also to FIG. 8, the vulcanized and molded workpiece is transported by the second movable transportation device 5 to the first cooling tray assembly 6 for natural cooling and shape fixing. The first cooling tray assembly 6 may receive at least two workpieces placed thereon for alternating.

Referring to FIGS. 2 and 4-8, the second vulcanization module 13 has a structure and operation that are identical to the structure and operation described above and the difference is that the second vulcanization module 13 is operable for carrying out asynchronous operation with that of the first vulcanization module 1 to manufacture products of different sizes, wherein the first vulcanization module 1 and the second vulcanization module 13 are combinable with each other or are separable from each other. Thus, repeated description will be omitted for those identical structure and operation.

Referring to all the drawings, the present invention provides the following advantages:

(1) The use of the first material feeding tray assembly 2 and the first cooling tray assembly 6 allows for saving the time for repeated placing of workpieces and allows for simultaneous cooling of multiple products and thus enhancement of manufacturing efficiency. In other words, an integrated combination is achieved for carrying out production in a manner of being simultaneous and synchronous for the same product specification or in a manner of being not simultaneous and asynchronous for products of different specifications.

(2) The use of the first movable transportation device 3 and the second movable transportation device 5 to conduct transportation or to proceed with picking and placing for replacing human labor can achieve the efficacies of saving human labor for transportation, enhancing operation efficiency, and reducing the chance of damaging products.

(3) The first vulcanization device 4 is monitored and assisted by the first positioning safety device 7 so that with such an arrangement, the first positioning safety device 7 controls and monitors any potential risk of the first vulcanization device 4 falling or detaching during the process of vulcanization or maintenance and repairing so as to reduce the occurrence of accidents.

(4) The workpiece is heated and softened by the first heating device 11 and a recessed portion of the heated and softened workpiece is driven outward and separated from the mold by means of the first separation and mold release device 9. With such an arrangement, an efficacy of preventing the recessed portion of the workpiece from damage during the process of separation from the mold can be achieved.

(5) The combination and separate operations of the first vulcanization module 1 and the second vulcanization module 13 and the second single-actuation controller 24 and the first single-actuation controller 12 allow the second vulcanization module 13 and the first vulcanization module 1 to carry out different operations in an asynchronous manner to simultaneously manufacture different sizes of tires thereby enhancing manufacturing efficiency and the first vulcanization module 1 and the second vulcanization module 13 are combinable with each other or are independently operable

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A vulcanization machine, comprising:
a first vulcanization module, which comprises:
a first material feeding tray assembly, which receives multiple workpieces to place thereon,
a first movable transportation device, which is arranged at one side of the first material feeding tray assembly to transport the workpiece,
a first vulcanization device, which is arranged at one side of the first movable transportation device to receive the workpiece of the first movable transportation device for carrying out vulcanization and molding,
a second movable transportation device, which is arranged at one side of the first vulcanization device to transport the workpiece that is vulcanized by the first vulcanization device, and
a first cooling tray assembly, which is arranged at one side of the second movable transportation device to receive the workpiece of the second movable transportation device for carrying out cooling;
a first single-actuation controller, which is arranged at one side of the first vulcanization module to control a manufacturing process of the first vulcanization module;
a second vulcanization module, which is arranged at one side of the first vulcanization module and is operable in a manner of being asynchronous with the operation of the first vulcanization module, the second vulcanization module comprising:
a second material feeding tray assembly, which receives multiple workpieces to place thereon,
a third movable transportation device, which is arranged at one side of the second material feeding tray assembly to transport the workpiece,
a second vulcanization device, which is arranged at one side of the third movable transportation device to receive the workpiece of the third movable transportation device for carrying out vulcanization and molding,
a fourth movable transportation device, which is arranged at one side of the second vulcanization device to transport the workpiece that is vulcanized by the second vulcanization device, and
a second cooling tray assembly, which is arranged at one side of the fourth movable transportation device to receive the workpiece of the fourth movable transportation device for carrying out cooling; and
a second single-actuation controller, which is arranged at one side of the second vulcanization module to control a manufacturing process of the second vulcanization module;
wherein the first vulcanization module and the second vulcanization module are combinable with each other or are independently operable, so that the first and second vulcanization module are operated to carry out different operations in an asynchronous manner to simultaneously manufacture workpieces of different sizes.

2. The vulcanization machine according to claim 1, wherein the first vulcanization module further comprises a first positioning safety device, which is arranged at opposite sides of the first vulcanization device, and the second vulcanization module further comprises a second positioning safety device, which is arranged at opposite sides of the second vulcanization device.

3. The vulcanization machine according to claim 1, wherein the first vulcanization module further comprises a first positioning centering device, which is arranged at a center of the first vulcanization device, and the second vulcanization module further comprises a second positioning centering device, which is arranged at a center of the second vulcanization device.

4. The vulcanization machine according to claim 1, wherein the first vulcanization module further comprises a first separation and mold release device, which is arranged on one surface of the first material feeding tray assembly, and the second vulcanization module further comprises a second separation and mold release device arranged on one surface of the second material feeding tray assembly.

5. The vulcanization machine according to claim 1, wherein the first vulcanization module further comprises a first mold height adjustment device, which is arranged on one surface of the first vulcanization device, and the second vulcanization module further comprises a second mold height adjustment device, which is arranged on one surface of the second vulcanization device.

6. The vulcanization machine according to claim 1, wherein the first vulcanization module further comprises at least one first heating device, which is arranged at one side of the first vulcanization device, and the second vulcanization module further comprises at least one second heating device, which is arranged at one side of the second vulcanization device.

7. (canceled)
